(19) United States
(12) Patent Application Publication
(10) Pub. No.: US 2024/0082848 A1
(43) Pub. Date: Mar. 14, 2024

(54) AUTOMATIC DISPENSING DEVICE

(71) Applicant: Shimadzu Corporation, Kyoto-shi (JP)

(72) Inventor: Koki MIYAZAKI, Kyoto-shi (JP)

(21) Appl. No.: 18/215,023

(22) Filed: Jun. 27, 2023

(30) Foreign Application Priority Data
Sep. 9, 2022 (JP) 2022-143866

(51) Int. Cl. B01L 9/00; B01L 3/02

(52) U.S. Cl. CPC B01L 9/50; B01L 3/0213

(57) ABSTRACT

An automatic dispensing device includes a gripper configured to grip a dispenser having a discharge nozzle with the discharge nozzle facing downward, a tip rack arrangement portion configured to arrange a tip rack in which pipette tips to be attached to the discharge nozzle are accommodated, a biasing member configured to bias the tip rack arrangement portion from below, and a moving unit configured to move the gripper relative to the tip rack arrangement portion.

### CROSS-REFERENCE TO RELATED APPLICATIONS

This application claims priority under 35 U.S. C. § 119 to Japanese Patent Application No. 2022-143866 filed on Sep. 9, 2022, the entire disclosure of which is incorporated herein by reference in its entirety.

### BACKGROUND OF THE INVENTION

### Field of the Invention

The present invention relates to an automatic dispensing device, and more particularly to an automatic dispensing device provided with a robot arm for gripping and operating a dispensing pipette.

### Description of the Related Art

The following description sets forth the inventor's knowledge of the related art and problems therein and should not be construed as an admission of knowledge in the prior art.

In an analysis of a sample using an analytical instrument, such as, e.g., a liquid chromatograph, a gas chromatograph, and a mass spectrometer, preprocessing, such as, e.g., extraction, purification, concentration, dilution, labeling, or staining of a detection target contained in the sample may be required prior to the analysis. Conventionally, in order to efficiently perform such preprocessing of a sample, an automatic dispensing device that automatically dispenses a liquid, such as, e.g., a sample liquid and a reagent, into a plurality of sample containers has been used.

Such an automatic dispensing device is provided with, for example, a dispensing pipette and a robot arm capable of gripping the dispensing pipette. The the robot arm grips the dispensing pipette, moves the dispensing pipette to a position above a tip rack to attach a pipette tip accommodated in the tip rack to a nozzle at the tip of the dispensing pipette. The robot arm moves the dispensing pipette to which the pipette tip is attached to a position of a predetermined collection container to collect a predetermined amount of liquid. Further, the robot arm moves the dispensing pipette to a position of a predetermined sample container to discharge the liquid into the sample container (for example, see Patent Document 1).

### PRIOR ART DOCUMENT

### Patent Document

Patent Document 1: Japanese Unexamined Patent Application Publication No. 2019-174369

### Problems to be Solved by the Invention

In the automatic dispensing device as described above, the robot arm is controlled such that the pipette tip is mounted at a predetermined insertion (fitting) depth with respect to the nozzle at the tip of the dispensing pipette so that a minute amount of liquid can be accurately collected and discharged. Specifically, the robot arm moves the dispensing pipette to a predetermined position above the tip rack and then lowers the dispensing pipette by a predetermined distance to insert the tip of the nozzle into the pipette tip.

However, the bottom position of the nozzle and the distance from the bottom position to the pipette tip at the start of descending the pipette vary due to factors, such as, e.g., the limit of position reproducibility of the robot arm and dimensional errors of the pipette tip and the tip rack. Therefore, even if the robot arm is controlled to lower the dispensing pipette by a distance predetermined in advance as a distance required to mount the pipette tip on the nozzle of the dispensing pipette at a constant fitting depth, there may occur an insufficient mating depth of the pipette tip to the nozzle or mechanical damage due to excessive insertion of the nozzle into the pipette tip.

### SUMMARY OF THE INVENTION

An object to be solved by the present invention is to provide an automatic dispensing device capable of preventing poor attachment of a pipette tip to a nozzle of a dispensing pipette.

### Means for Solving the Problems

An automatic dispensing device according to the present invention made to solve the above-described problem is provided with:
a gripper configured to grip a dispenser having a discharge nozzle with the discharge nozzle facing downward;
a tip rack arrangement portion configured to arrange a tip rack in which a pipette tip to be attached to the discharge nozzle is accommodated;
a biasing member configured to bias the tip rack arrangement portion from below; and
a moving unit configured to move the gripper relative to the tip rack arrangement portion.

### Effects of the Invention

In the present invention, the moving unit moves the gripper gripping the dispenser and pushes the discharge nozzle of the dispenser from above into the pipette tip in the tip rack arranged on the tip rack arrangement portion. Thus, the discharge nozzle and the pipette tip are lowered together with the tip rack arrangement portion against the biasing force of the biasing member, and at this time, the discharge nozzle is pushed into the pipette tip by a constant force corresponding to the biasing force of the biasing member. For this reason, variation in the fitting depth of the pipette tip with respect to the discharge nozzle can be suppressed, and the pipette tip can always be attached to the discharge nozzle at a constant fitting depth, so that a small amount of liquid can be accurately sampled or discharged.

### BRIEF DESCRIPTION OF THE DRAWINGS

Some preferred embodiments of the present invention are shown by way of example, and not limitation, in the accompanying figures.

FIG. 1 is a plan view showing a schematic configuration of a sample preprocessing device according to one embodiment of the present invention.

FIG. 2 is a diagram showing a motor-driven micropipette as one example of a dispenser to be held by a robot arm provided in a sample preprocessing device.

FIG. 3 is a perspective view showing a state in which a tip rack is arranged on a tip rack arrangement portion provided in a sample preprocessing device.

FIG. 4 is a side view showing a state in which a tip rack is arranged on a tip rack arrangement portion provided in a sample preprocessing device.

### DETAILED DESCRIPTION OF THE PREFERRED EMBODIMENTS

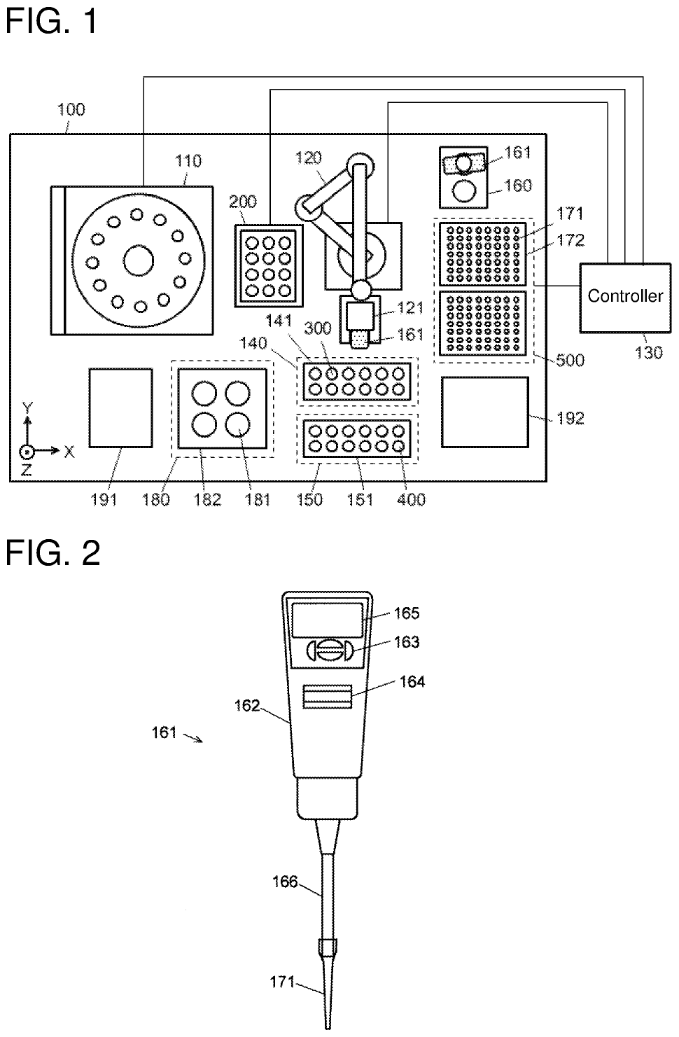

Hereinafter, a sample preprocessing device which is one embodiment of an automatic dispensing device according to the present invention will be described with reference to the attached drawings. FIG. 1 is a top view of the schematic configuration of a sample preprocessing device according to this embodiment. In FIG. 1, the horizontal direction (right-left direction) is defined as an X direction, a vertical direction (up-down direction) is defined as a Y direction, and a direction perpendicular to the X direction and the Y direction is defined as a Z direction.

This sample preprocessing device is provided with a housing 100, a temperature controller 200 (corresponding to the sample container holder in the present invention) arranged in the housing 100, a centrifuge 110, a dispenser 161, and a robot arm 120 (corresponding to a drive unit in the present invention), and a controller 130. In the housing 100, a column rack arrangement portion 140, a tube rack arrangement portion 150, a dispenser housing 160, a tip rack arrangement portion 500, a reagent rack arrangement portion 180, a consumable disposal portion 191, and a preprocessed sample housing 192 are further provided.

In the column rack arrangement portion 140, a column rack 141 accommodating a plurality of spin columns 300 is arranged so as to surround the robot arm 120. A tube rack 151 accommodating a plurality of collection tubes 400 is arranged in the tube rack arrangement portion 150. One or a plurality of dispensers 161 is accommodated in the dispenser housing 160. In the tip rack arrangement portion 500, a tip rack 172 accommodating a plurality of pipette tips 171 is arranged. In the reagent rack arrangement portion 180, the reagent rack 182 accommodating one or more reagent containers 181 is arranged. In the consumable disposal portion 191, used spin columns 300 and pipette tips 171 are discarded. In the preprocessed sample housing 192, a collection tube 400 in which the preprocessed sample is contained is accommodated.

A spin column 300 has a cylindrical main body having a circular upper opening and a lower opening smaller in diameter than the upper opening, and a filter held therein, and can be inserted into the upper portion of the collection tube 400.

As the collection tube 400, it is possible to use a so-called microtube including a cylindrical or substantially conical main body which is closed at the bottom and opened at the top, and a lid connected to the peripheral edge of the upper end portion of the main body via a hinge and can close the upper opening of the main body. However, the collection tube 400 according to this embodiment is not limited to such a microtube, and may be any tube as long as a liquid can be accommodated and the spin column 300 can be mounted.

As the dispenser 161 in this embodiment, for example, an electric micropipette as shown in FIG. 2 is used. Hereinafter, the description will be made in a case where the dispenser 161 is a micropipette 161.

The micropipette 161 is provided with a grip portion 162, a cylinder provided inside the gripper (not shown), a plunger (not shown), a motor for driving the plunger (not shown), an operation button 163 provided to the grip portion 162, a push button 164 provided to the grip portion 162, a display panel 165 provided to the grip portion 162, and a tubular discharge nozzle 166 connected to the lower end of the cylinder and projecting outward from the lower part of the grip portion 162.

A disposable pipette tip 171 is attached to the lower end of the discharge nozzle 166. By operating the operation button 163 or the push button 164 in a state in which the pipette tip 171 is attached to the lower end of the discharge nozzle 166 to move the plunger vertically in the cylinder, a liquid can be sucked into the pipette tip 171 or a liquid can be discharged from the pipette tip 171.

As the dispenser 161, in place of the above-described electric micropipette, for example, a so-called manual micropipette may be used in which a push rod connected to the upper end of the plunger and a spring for biasing the push rod upward are provided, and the plunger is moved upward and downward by pushing down a push button provided at the upper end of the push rod or releasing the push-down of the button.

The robot arm 120 includes a hand portion 121 that can grip the spin column 300, the collection tube 400, and the grip portion 162 of the micropipette 161 and can operate the operation button 163 and the push button 164 provided on the micropipette 161. The robot arm 120 and the hand portion 121 correspond to the moving unit and a gripper of the present invention, respectively.

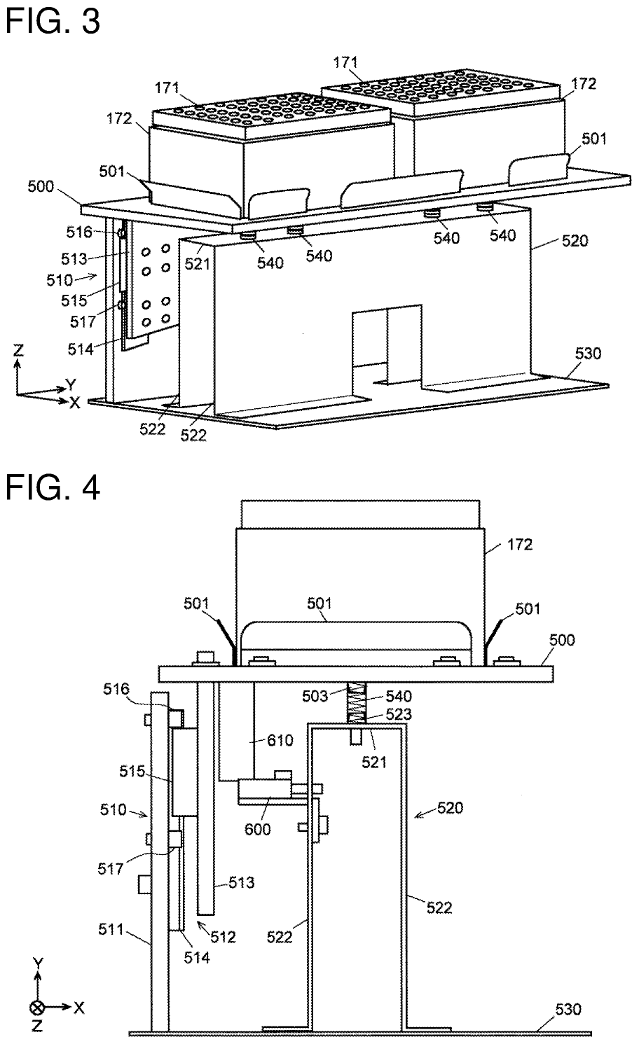

As shown in FIG. 3 and FIG. 4, the tip rack arrangement portion 500 is supported by a support portion 510 and a support leg portion 520 upwardly provided on the base portion 530. Each of the tip rack arrangement portion 500 and the base portion 530 is formed of a rectangular plate-shaped member and is arranged such that the long side is parallel to the Y direction and the short side is parallel to the X direction.

A plurality of leaf spring members 501 is fixed to the upper surface of the tip rack arrangement portion 500 so as to surround a rectangular region, and one or a plurality of (two in FIG. 3) tip racks 172 is arranged in the region surrounded by the leaf spring members 501. Hereinafter, the region is referred to as a rack arrangement region. The tip rack 172 arranged in the rack arrangement region is held immovably in any X, Y, and Z directions by the elastic forces of the leaf spring members 501.

The support portion 510 includes a support wall portion 511 vertically provided on the base portion 530 along one long side of the base portion 530, and a linear plate 513 which is attached to the support wall portion 511 via a linear guide 512 and is movable in the Z direction (vertical direction). The linear guide 512 is attached to each end of the support wall portion 511 in the Y direction.

Each linear guide 512 is composed of a guide rail 514 fixed to the support wall portion 511, a carriage 515 that slides on the guide rail 514 in the Z direction, and a ball retainer (not shown) arranged on the sliding portion in the carriage 515. The linear plate 513 is fixed to each carriage 515.

The tip rack arrangement portion 500 is fixed to the upper end of the linear plate 513 such that the upper surface thereof is substantially parallel to the X-Y plane. With the above-described configuration, the tip rack arrangement portion 500 moves vertically while maintaining the state in which the upper surface thereof is parallel to the X-Y plane.

The tip rack arrangement portion 500 is fixed to the upper end of the linear plate 513 on the lower surface outside the rack arrangement region, and at this time, the long side end portion of the tip rack arrangement portion 500 is positioned above the support wall portion 511. Further, a pair of upper regulation protrusions 516 and a pair of lower regulation protrusions 517 are fixed to both sides of the guide rail 514 of the support wall portion 511, and the carriage 515 moves vertically between the upper regulation protrusions 516 and the lower regulation protrusions 517 along the guide rail 514. That is, the movements of the tip rack arrangement portion 500 in the upward direction and the downward direction are restricted in a range until the upper end portion of the carriage 515 comes into contact with the upper regulation protrusion 516 and a range until the lower end portion comes into contact with the lower regulation protrusion 517, respectively.

As the linear guide 512, in addition to the ball type linear guide described above, there is a sliding type linear guide in which a lubricant is provided on the sliding portion in the carriage, and the sliding type linear guide may be used instead of the ball type linear guide.

The support leg portion 520 is provided upwardly along the Y direction in the vicinity of substantially the center in the X direction on the upper surface of the base portion 530, and is provided with an elongated top plate 521 which is substantially parallel to the X-Y plane, and a pair of leg portions 522 which extends downward from both end portions of the top plate 521 in the X direction. The top plate 521 is located at a position lower than the support wall portion 511, and four compression coil springs 540 are interposed between the upper surface thereof and the tip rack arrangement portion 500.

Specifically, four protrusions 503 are provided on the lower surface of the rack arrangement region of the tip rack arrangement portion 500 in the vicinity of the center in the X direction, four protrusions 523 corresponding to the protrusions 503 are provided on the upper surface of the top plate 521, and both end portions of the compression coil spring 540 are fitted and inserted into the protrusion 503 and the protrusion 523 which form a pair. The compression coil spring 540 corresponds to the biasing member of the present invention.

In a state (initial state) in which the tip rack 172 in which the pipette tips 171 are accommodated is arranged in the tip rack arrangement portion 500, the weight of the tip rack arrangement portion 500 and the leaf spring member 501, the height position of the support wall portion 511 and the support leg portion 520 are set so that the compression coil spring 540 is compressed from its free length and the tip rack arrangement portion 500 is not in contact with the upper edge of the support wall portion 511, and a compression coil spring 540 with a predetermined free length and a spring constant is employed. As a result, in the initial state, the tip rack arrangement portion 500 is biased upward by the compression coil spring 540 and is movable downward.

In this embodiment, a lowering detection unit for detecting that the tip rack arrangement portion 500 is lowered by a predetermined length or more from the initial state is provided. The lowering detection unit can be configured by, for example, a photosensor 600 that is attached to a pair of leg portions 522 of the support leg portion 520 (in this embodiment, the leg portion 522 on the linear plate 513 side) and includes a light-receiving portion and a light-emitting portion, and a light shielding plate 610 attached to the lower surface of the tip rack arrangement portion 500.

The light shielding plate 610 is configured such that, when the tip rack arrangement portion 500 is lowered by the predetermined length or more from the initial state, the lower end portion of the light shielding plate 610 enters between the light-receiving portion and the light-emitting portion of the photosensor 600 to shield the light emitted from the light-emitting portion toward the light-receiving portion.

The temperature controller 200, the centrifuge 110, the robot arm 120, and the photosensor 600 are controlled by the controller 130. The light reception signal of the photosensor 600 is input to the controller 130. The reality of the controller 130 is a dedicated computer or a general-purpose computer, such as, e.g., a personal computer. The functions of the controller 130 in this embodiment are realized by executing a predetermined program installed in the computer. In FIG. 1, the controller 130 is arranged outside the housing 100, but the controller 130 may be arranged inside the housing.

Although not shown for the sake of simplicity, an input unit composed of a keyboard, operation buttons, or the like and a display unit composed of a liquid-crystal display or the like are connected to the controller 130. When a light-receiving signal from the light-receiving portion of the photosensor 600 is input even if the micropipette 161 is lowered in the step of attaching the pipette tip 171 to the discharge nozzle 166 of the micropipette 161, the controller 130 determines that some troubles have occurred and displays the fact on the display unit. Some defects are, for example, that the tip rack 172 that does not accommodate the pipette tip 171 is mistakenly placed on the tip rack arrangement portion 500, or that the discharge nozzle 166 of the micropipette 161 is damaged.

Next, the preprocessing flow by the preprocessing device according to this embodiment will be described. At the start of the preprocessing, the column rack 141 and the tube rack 151 hold a plurality of spin columns 300 and a plurality of collection tubes 400, respectively. At this time, a predetermined amount of a liquid sample is added to each spin column 300 in advance, and a target component in the sample is adsorbed on the filter.

First, under the control of the controller 130, the robot arm 120 grips the collection tube 400 held in the tube rack 151 with the hand portion 121 and accommodates the collection tube 400 in the tube accommodating portion 204 of the temperature controller 200, and then grips the spin column 300 held in the column rack 141 with the hand portion 121 and mounts the spin column 300 on the collection tube 400 on the temperature controller 200.

Next, the robot arm 120 grips the micropipette 161 accommodated in the dispenser housing 160 with the hand portion 121 such that the discharge nozzle 166 faces downward and moves the micropipette 161 to a predetermined position directly above the tip rack arrangement portion 500. Then, the micropipette 161 is lowered toward any one of the pipette tips 171 accommodated in the tip rack 172, and the tip of the discharge nozzle 166 of the micropipette 161 is pushed into the pipette tip 171 from the upper opening of the pipette tip 171, and then the pipette tip 171 is mounted on the discharge nozzle 166. At this time, the controller 130 drives the robot arm 120 such that the discharge nozzle 166 is pushed into the pipette tip 171 by a constant force corresponding to the biasing force of the compression coil spring 540.

For example, as the compression coil spring 540, it is preferable to adopt a spring having a spring constant of 0.30 N/mm to 1.50 N/mm and a free length of 100.0 mm to 20.0 mm. In a case where the weight of the tip rack arrangement portion 500 and the leaf spring member 501 and the height positions of the support wall portion 511 and the support leg portion 520 are set such that the length of the compression coil spring 540 when the tip rack arrangement portion 500 is at the initial position is 78.0 mm to 16.0 mm, it is preferable to drive the robot arm 120 so that the discharge nozzle 166 is pushed in with a force of 30.0 N to 42.0 N against the pipette tip 171. By doing so, the discharge nozzle 166 and the pipette tip 171 are lowered by about 3.0 mm against the biasing force of the compression coil spring 540 (that is, the compression coil spring 540 is compressed by about 3.0 mm, and the tip rack arrangement portion 500 is lowered by about 3.0 mm from the initial state).

This absorbs variations in the lowering distance from a predetermined position directly above the tip rack arrangement portion 500 to the pipette tip 171 due to factors, such as, e.g., variations in the mounting state of the tip rack 172 with respect to the tip rack arrangement portion 500, dimensional errors of the pipette tip 171 and the tip rack 172, and the limit of the position reproducibility of the robot arm 120. Therefore, the pipette tip 171 can be attached to the discharge nozzle 166 of the micropipette 161 at a constant fitting depth. Further, mechanical damage due to excessive pressing of the discharge nozzle 166 against the pipette tip 171 can also be suppressed.

When the pipette tip 171 is attached to the micropipette 161 held by the hand portion 121 of the robot arm 120 as described above, the robot arm 120 moves the micropipette 161 to insert the tip of the pipette tip 171 into any one of the reagent containers 181 on the reagent rack 182. When an operation button or the like provided on the micropipette 161 is operated, a predetermined amount of a reagent is collected.

Thereafter, the robot arm 120 moves the micropipette 161 to a position above the collection tube 400 and the spin column 300 accommodated in any one of the tube accommodating portions 204 on the temperature controller 200 and lowers the micropipette 161 by a predetermined distance from a predetermined height position immediately above the tube accommodating portion 204 to bring the tip of the pipette tip 171 into contact with, for example, the vicinity of the center of the upper surface of the filter in the spin column 300. In this state, when the operation button or the like provided on the micropipette 161 is operated, the robot arm 120 makes the pipette tip 171 discharge the reagent from the pipette tip 171.

The distance by which the micropipette 161 is lowered is set on the assumption that the pipette tip 171 is attached to the discharge nozzle 166 of the micropipette 161 with a predetermined fitting depth. Therefore, when the fitting depth of the pipette tip 171 with respect to the discharge nozzle 166 varies, the position of the tip of the pipette tip 171 when the micropipette 161 is lowered by the distance varies, and the tip of the pipette tip 171 excessively contacts or does not contact the upper surface of the filter of the spin column 300.

On the other hand, in this embodiment, since the pipette tip 171 can be attached to the discharge nozzle 166 at a predetermined fitting depth as described above, the reagent can be discharged in a state in which the tip of the pipette tip 171 is in contact with the upper surface of the filter, which makes it possible to always dispense a constant amount of the reagent.

Although some embodiments for carrying out the present invention have been described by exemplifying specific examples, the present invention is not limited to the above-described configurations, and appropriate modifications are allowed.

For example, the biasing member in the present invention is not limited to a compression coil spring. For example, it may be configured such that a rack arrangement portion is biased upward by a plate spring or a block made of an elastic body, or biased by a repulsive force of a magnet.

Further, the number of the compression coil springs is not limited to four, but may be one to three, or may be five or more. In a case where the number of the compression coil springs is one, the compression coil spring is preferably arranged in the vicinity of the center of gravity of the rack arrangement portion. In a case where the number of the compression coil springs is plural, the compression coil spring is preferably arranged point-symmetrically with respect to the center of gravity of the rack arrangement portion. With this arrangement, the entire rack arrangement portion can be uniformly biased in a well-balanced manner.

Further, the automatic dispensing device according to the present invention may be an apparatus that performs only dispensing without preprocessing, in addition to the preprocessing device as described in the above embodiment.

Further, the dispenser 161 is not limited to a single-channel micropipette, and a multichannel micropipette may be used.

Further, in the above-described embodiment, the reagent is dispensed by moving and operating the dispenser 161 by the robot arm 120, but the present invention is not limited thereto. It may be configured such that it is provided with a pipe, one end of which is inserted into a reagent container and the other end thereof is fitted with a nozzle (corresponding to a discharge unit in the present invention) for discharging a liquid, a pump configured to suck the reagent from the one end of the pipe and discharge the reagent from the other end of the pipe, and a moving mechanism (corresponding to a drive unit in the present invention) configured to move the nozzle up and down, forward and backward, and left and right, the reagent is discharged in a state in which the tip of the nozzle is brought into contact with a discharge target position in the sample container.

Further, in the above-described embodiment, the robot arm 120 moves the hand portion 121 holding the micropipette 161, but the pipette tip 171 may be attached to the discharge nozzle 166 of the micropipette 161 held by the hand portion 121 by moving the tip rack arrangement portion 500 without moving the hand portion 121.

### [Aspect]

It will be apparent to those skilled in the art that the exemplary embodiments described above are specific examples of the following aspects.

### (Item 1)

The automatic dispensing device as recited in Item 1 includes:
a gripper configured to grip a dispenser having a discharge nozzle with the discharge nozzle facing downward;
a tip rack arrangement portion configured to arrange a tip rack in which a pipette tip to be attached to the discharge nozzle is accommodated;
a biasing member configured to bias the tip rack arrangement portion from below; and
a moving unit configured to move the gripper relative to the tip rack arrangement portion.

In the automatic dispensing device as recited in the above-described Item 1, the moving unit moves the gripper gripping the dispenser to push the discharge nozzle of the dispenser from above into the pipette tip in the tip rack placed on the tip rack arrangement portion, thereby attaching the pipette tip to the discharge nozzle. At this time, the discharge nozzle and the pipette tip are lowered together with the tip rack arrangement portion against the biasing force of the biasing member, but at this time, since the discharge nozzle is pushed into the pipette tip by a constant force corresponding to the biasing force of the biasing member, it is possible to suppress variations in the fitting depth of the pipette tip with respect to the discharge nozzle and to always attach the pipette tip to the discharge nozzle at a constant fitting depth. Further, since the fitting depth of the pipette tip with respect to the discharge nozzle is constant, it is possible to always perform dispensing of a constant amount in a case where so-called contact dispensing is performed in which the dispensing pipette is moved to a predetermined position directly above the sample container by the robot arm, the pipette tip is lowered by a predetermined distance using the position as a reference position, and the tip of the pipette tip is brought into contact with a predetermined site in the sample container to discharge the liquid.

### (Item 2)

According to an automatic dispensing device as recited in the above-described Item 2, in the automatic dispensing device as recited in the above-described Item 1, it further includes a support portion configured to support the tip rack arrangement portion so as to be vertically movable in a direction perpendicular to an upper surface of the tip rack arrangement portion.

In general, an automatic dispensing apparatus is installed such that the upper surface of the tip rack arrangement portion is horizontal. Therefore, according to the automatic dispensing device as recited in Item 2, even when the discharge nozzle is pushed into the pipette tip in the tip rack placed in the tip rack placement portion and the tip rack placement portion is lowered, the tip rack can be prevented from being inclined.

### (Item 3)

According to an automatic dispensing device as recited in the above-described Item 3, in the automatic dispensing device as recited in the above-described Item 1 or Item 2, the moving unit is configured to press the discharge nozzle of the dispenser gripped by the gripper of the moving unit into a pipette tip accommodated in the tip rack arranged on the tip rack arrangement portion with a force of 30.0 N to 42.0 N against a biasing force of the biasing member.

According to the automatic dispensing device as recited in the above-described Item 3, the pipette tip can be attached to the discharge nozzle of the dispenser at a constant fitting depth.

### (Item 4)

According to an automatic dispensing device as recited in the above-described Item 4, in the automatic dispensing device as recited in any one of the above-described Items 1 to 3, it further includes a lowering detection unit configured to detect that the tip rack arrangement portion is lowered by a predetermined amount or more.

According to the automatic dispensing device as recited in the above-described Item 4, it is possible to recognize that the pipette tip cannot be mounted on the discharge nozzle of the dispenser due to a failure such as erroneous placement of the tip rack in which the pipette tip is not accommodated on the tip rack arrangement portion or breakage of the discharge nozzle of the micropipette.

### DESCRIPTION OF REFERENCE SYMBOLS

100: Housing
110: Centrifuge
120: Robot arm
121: Hand portion
130: Controller
161: Dispenser (micropipette)
166: Discharge nozzle
171: Pipette tip
172: Tip rack
181: Reagent container
500: Tip rack arrangement portion
510: Support portion
512: Linear guide
520: Support leg portion
540: Compression coil spring
600: Photosensor
610: Light shielding plate

1. An automatic dispensing device comprising:
a gripper configured to grip a dispenser having a discharge nozzle with the discharge nozzle facing downward;
a tip rack arrangement portion configured to arrange a tip rack in which a pipette tip to be attached to the discharge nozzle is accommodated;
a biasing member configured to bias the tip rack arrangement portion from below; and
a moving unit configured to move the gripper relative to the tip rack arrangement portion.

2. The automatic dispensing device as recited in claim 1, further comprising:
a support portion configured to support the tip rack arrangement portion so as to be vertically movable in a direction perpendicular to an upper surface of the tip rack arrangement portion.

3. The automatic dispensing device as recited in claim 1,
wherein the moving unit is configured to press the discharge nozzle of the dispenser gripped by the gripper of the moving unit into a pipette tip accommodated in the tip rack arranged on the tip rack arrangement portion with a force of 30.0 N to 42.0 N against a biasing force of the biasing member.

4. The automatic dispensing device as recited in claim 1, further comprising:
a lowering detection unit configured to detect that the tip rack arrangement portion is lowered by a predetermined amount or more.
